(19) United States
(12) Patent Application Publication
(10) Pub. No.: US 2011/0221663 A1
(43) Pub. Date: Sep. 15, 2011

(54) EDGE TYPE BACKLIGHTING MODULE

(75) Inventors: Chung-I CHIANG, Taoyuan (TW); Hung-Yi Lin, Taoyuan (TW); Hsien-Lung Ho, Taoyuan (TW)

(73) Assignee: WALSIN LIHWA CORPORATION, Taoyuan (TW)

(21) Appl. No.: 12/722,929

(22) Filed: Mar. 12, 2010

(51) Int. Cl. G09G 3/36; F21V 7/04

(52) U.S. Cl. 345/102; 362/609; 362/607; 250/504 R

(57) ABSTRACT

An edge type backlighting module is disclosed in the present invention. The edge type backlighting module includes at least one light source array for providing light beams; at least one reflecting mirror, rotating within a specified angle, for reflecting the light beams; and a light adjusting medium for adjusting outgoing directions of the reflected light beams. It further has at least one infrared sensor for detecting light beams reflected from a surface of the light adjusting medium when a user touches the surface and generating a signal representing a touch location.

### FIELD OF THE INVENTION

The present invention relates generally to a backlighting module. More specifically, the present invention relates to an edge type backlighting module which uses reflecting mirrors for guiding light beams.

### BACKGROUND OF THE INVENTION

A common liquid crystal display usually includes a component with color display function, such as a liquid crystal display panel. As the liquid crystal display panel does not emit light, a backlight module must be disposed below the liquid crystal display panel to serve as a light source to illuminate the liquid crystal display panel for displaying images.

FIG. 1 is a schematic sectional view of a conventional edge type backlight module 10. The edge type backlight module 10 is composed of a lamp holder 101, a lamp cover 102, a Cold Cathode Fluorescent Lamp (CCFL) 103, a light guide plate 104, patterns 105, a reflector 106, a down diffusing sheet 107, two prism lenses 108 and a top diffusing sheet 109. The lamp holder 101 and lamp cover 102 are used to fix the cold cathode fluorescent lamp 103. The light guide plate 104 is for guiding light beams from the cold cathode fluorescent lamp 103 to a top panel. The patterns 105 are used to help reflect some light beams back rather than being refracted out of the light guide plate 104 downwards. The reflector 106 is used to reflect back light beams from the light guide plate 104 once they emit out of the light guide plate 104. The down diffusing sheet 107 and the top diffusing sheet 109 can scatter light beams so that a uniform backlight can be achieved. With the help of prism lens 108 to direct light beams upwards, the edge type backlight module 10 is widely applied to many liquid crystal displays.

From FIG. 1, we can also find that size of the edge type backlight module 10 can not be reduced to a significant extent due to the complex structure and size of the cold cathode fluorescent lamp 103. In addition, lighting efficiency is poor. According to the structure of the edge type backlight module 10, the lighting efficiency is only 28%. If the cold cathode fluorescent lamp 103 generates 100 lm/w, only 28 lm/w is available from the top diffusing sheet 109. Meanwhile, the edge type backlight module 10 can not provide any touch functions for users. Therefore, some inventions had shown improvements to these drawbacks.

U.S. Pat. No. 5,613,751 provides a light emitting panel assemblies which include light emitting panel members and one or more light sources positioned/embedded in a light transition area, which increases the efficiency of light entering the panel members along the light input area to be emitted from one or more light emitting surfaces along the length of the panel members. Light may be reflected or refracted by a surface which changes the path of a portion of light such that it enters the input area of the panel member at a more acceptable angle. A uniform light output distribution may be produced by utilizing a pattern of light extracting deformities. '751 has a slim structure for minimizing the whole backlight module and has good lighting efficiency. However, no touch function is available.

US Patent Publication No. 20070109463 shows a liquid crystal display including a planar array of transmissive liquid crystal display devices, and at least one laser diode device spaced apart from the planar array of liquid crystal display devices and configured to illuminate at least a subset of the liquid crystal display devices of the planar array of liquid crystal display devices such that, in operation, the laser diode device provides backlighting for the subset of liquid crystal display devices of the planar array of LCD devices. The invention uses laser diodes which could increase lighting efficiency. However, size of the device would be vast and there is still no touch function mentioned in the invention.

U.S. Pat. No. 7,573,465 provides an optical touch panel including a support, an optical light guide illumination assembly arranged along and above at least most of a periphery of the support to define a detection region, the assembly including at least one optical light guide and a light source arranged for directing light along the at least one optical light guide, at least one light detector, arranged to detect changes in the light received from the optical light guide illumination assembly produced by the presence of an object in the detection region and detection circuitry receiving at least one output from the at least one light detector and providing an output indication of the two dimensional location of the object present in the detection region. In addition to lack of touch function, the panel has a large size.

There is no method which provides an edge type backlighting module having small size, high lighting efficiency and touch function. The present invention provides a good solution to all the requirements at the same time.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In accordance with an aspect of the present invention, an edge type backlighting module includes: at least one light source array for providing light beams; at least one reflecting mirror, rotating within a specified angle, for reflecting the light beams; and a light adjusting medium for adjusting outgoing directions of the reflected light beams.

Preferably, the light adjusting medium further includes: a light guide for guiding the reflected light beams to uniformly illuminate from one end of the light guide to the other end thereof; a reflecting sheet, attached below the light guide, for reflecting the reflected light beams back to the light guide; and a diffusing sheet, provided on the light guide, for scattering the reflected light beams from the light guide.

Preferably, the reflecting sheet is made of a metal.

Preferably, the diffusing sheet is made of polyethylene terephthalate (PET) or polycarbonate (PC).

Preferably, the diffusing sheet includes a dispersing agent.

Preferably, the dispersing agent is made of acrylic, silicon dioxide, aluminum oxide, calcium oxide, magnesium oxide, silicone gel, polyester resin or a mixture thereof.

Preferably, the light source array and the reflecting mirror are assembled adjacent to each other.

Preferably, the light source array and the reflecting mirror are assembled at adjacent corners of the light adjusting medium.

Preferably, the reflecting mirrors are placed at diagonal corners of the light adjusting medium while the reflecting mirror has a number of two.

Preferably, the light source array and the reflecting mirror have the same number.

Preferably, the light source array includes red, green and blue laser diodes (LD).

Preferably, the edge type backlighting module further includes at least one infrared ray emitter placed in the light adjusting medium adjacent to the light source array for emitting infrared rays having infrared paths parallel to the diffusing sheet.

Preferably, the edge type backlighting module further includes at least one infrared sensor for detecting change of the infrared paths caused by depression of the light adjusting medium generated by touch of a user on the edge type backlighting module, and generating a signal representing a touch location.

Preferably, the reflecting mirror is a Micro Electro Mechanical Systems (MEMS) mirror.

### BRIEF DESCRIPTION OF THE DRAWINGS

FIG. 1 illustrates a traditional edge type backlighting module.

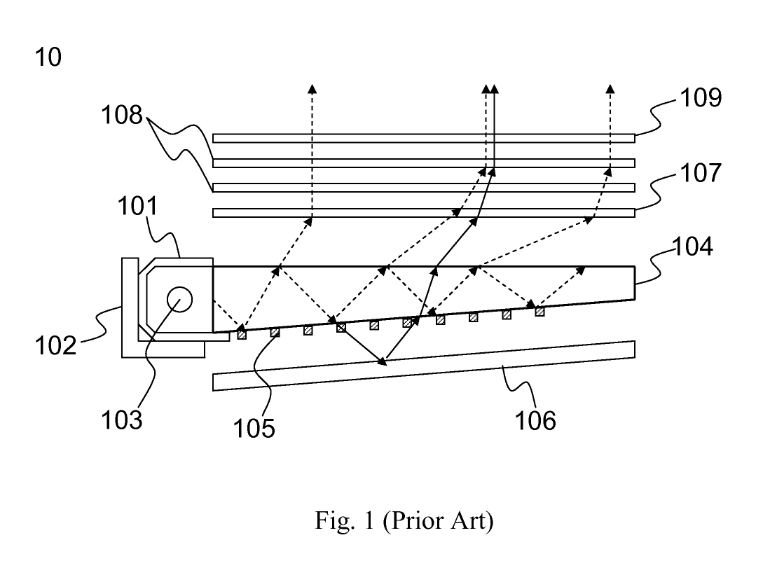

FIG. 2 illustrates a prior art of an edge type backlighting module.

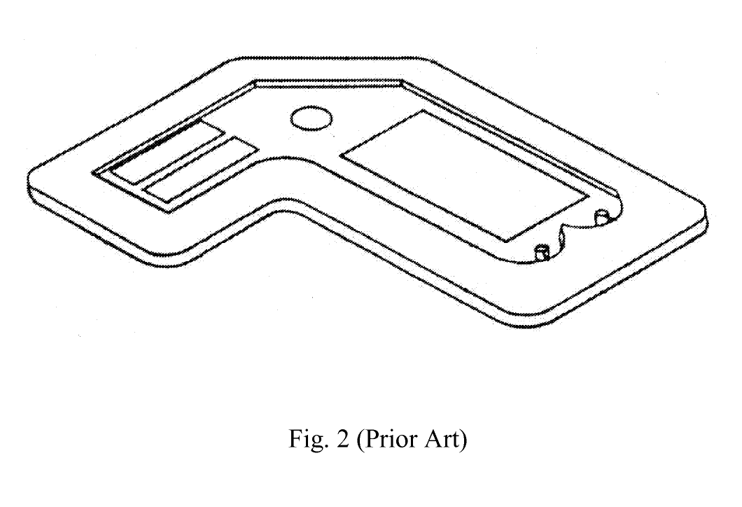

FIG. 3 illustrates another prior art of an edge type backlighting module.

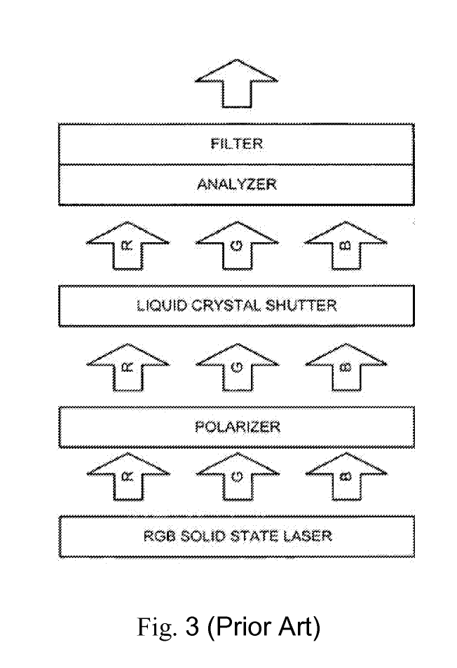

FIG. 4 illustrates still another prior art of an edge type backlighting module.

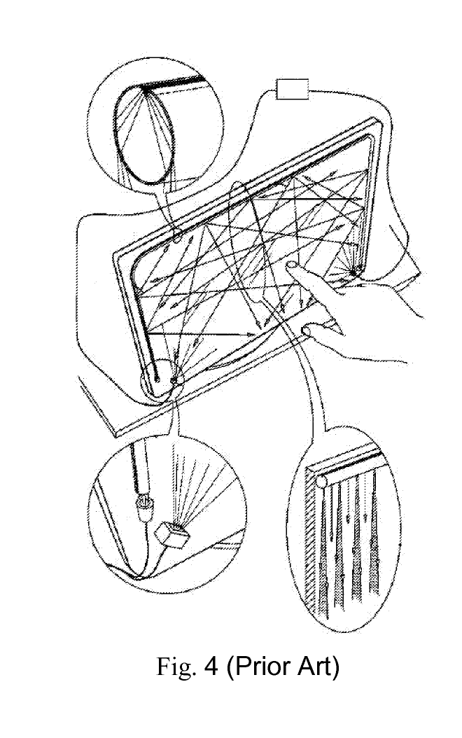

FIG. 5 shows a first embodiment of the present invention.

FIG. 6 illustrates rotation angles of reflecting mirrors in the first embodiment.

FIG. 7 is a cross-sectional view taken along line AA′ in FIG. 5.

FIG. 8 is a cross-sectional view taken along line BB′ in FIG. 5.

FIG. 9 is a cross-sectional view taken along line CC′ in FIG. 5.

FIG. 10 shows a second embodiment of the present invention.

FIG. 11 is a cross-sectional view taken along line AA′ in FIG. 10.

FIG. 12 illustrates a rotation angle of a reflecting mirror in the second embodiment.

FIG. 13 shows a third embodiment of the present invention.

FIG. 14 shows a fourth embodiment of the present invention.

FIG. 15 is a cross-sectional view taken along line AA′ in FIG. 14.

FIG. 16 is a cross-sectional view taken along line BB′ in FIG. 14.

### DETAILED DESCRIPTION OF THE PREFERRED EMBODIMENTS

For better understanding of the present invention, four embodiments are described below.

### First Embodiment

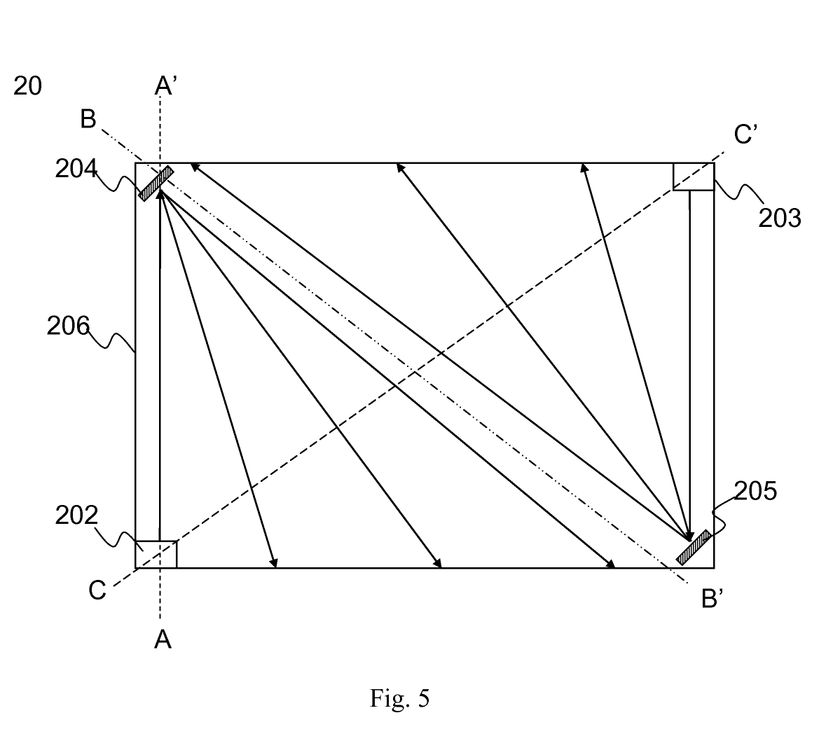

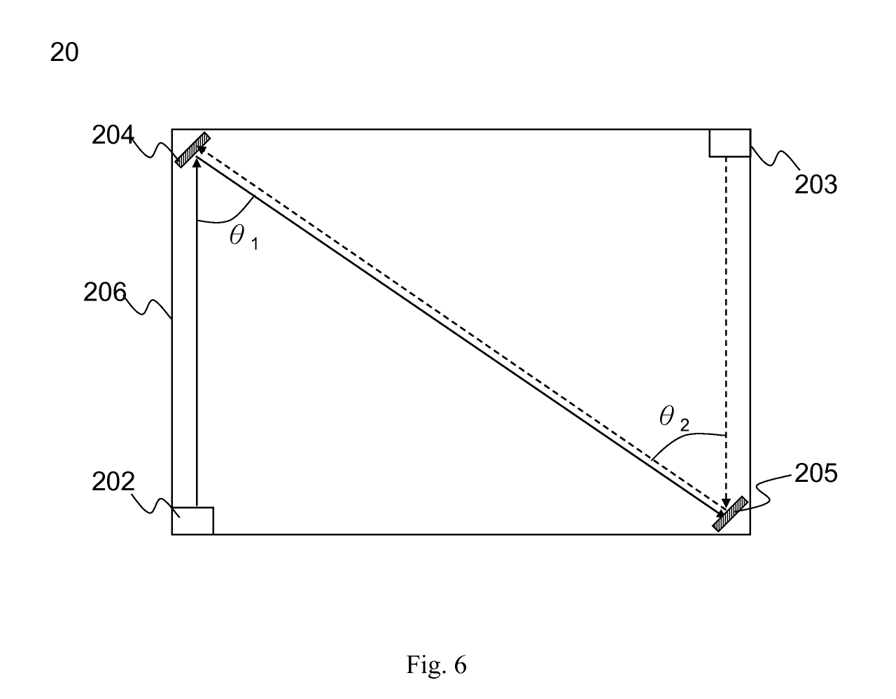

Please refer to FIG. 5 to FIG. 9. A first embodiment is illustrated. An edge type backlighting module 20 has a first light source array 202 and a second light source array 203 for providing light beams. The edge type backlighting module 20 also has a first reflecting mirror 204 and a second reflecting mirror 205. Each of the two reflecting mirrors 204 and 205 rotates within a specified angle, for reflecting the light beams from the first light source array 202 and second light source array 203, respectively. As shown in FIG. 6, θ₁ and θ₂ represent rotation angles for the first reflecting mirror 204 and second reflecting mirror 205, respectively.

The light source arrays 202 and 203 comprise red, green and blue laser diodes (LD). When the three color laser diodes are turned on at the same time, simulated white light can be generated. It is also a condition that one or two laser diodes are used to produce a specified color light as a backlight. The reflecting mirrors 204 and 205 are Micro Electro Mechanical Systems (MEMS) mirrors. In this embodiment, each of the reflecting mirrors 204 and 205 has a rotation axle perpendicular to the paperface of FIG. 5. It means that the two reflecting mirrors 204 and 205 can rotate to reflect light beams from the first light source array 202 and second light source array 203, respectively.

A light adjusting medium 206 is used for adjusting outgoing directions of the reflected light beams. The light adjusting medium 206 is composed of a light guide 2064 for guiding the reflected light beams to uniformly illuminate from one end of the light guide 2064 to the other end, a reflecting sheet 2066, attached below the light guide 2064, for reflecting the reflected light beams back to the light guide 2064, and a diffusing sheet 2062, provided on the light guide 2064, for scattering the reflected light beams from the light guide 2064.

The reflecting sheet 2066 is made of a metal. In this embodiment, the metal is silver. The diffusing sheet 2062 is made of polyethylene terephthalate (PET). In practice, polycarbonate (PC) can be the material for the diffusing sheet 2062. Preferably, the diffusing sheet 2062 contains a dispersing agent. Aluminum oxide is used as the dispersing agent in this embodiment. Of course, acrylic, silicon dioxide, calcium oxide, magnesium oxide, silicone gel, polyester resin or a mixture of the materials mentioned above can be applied.

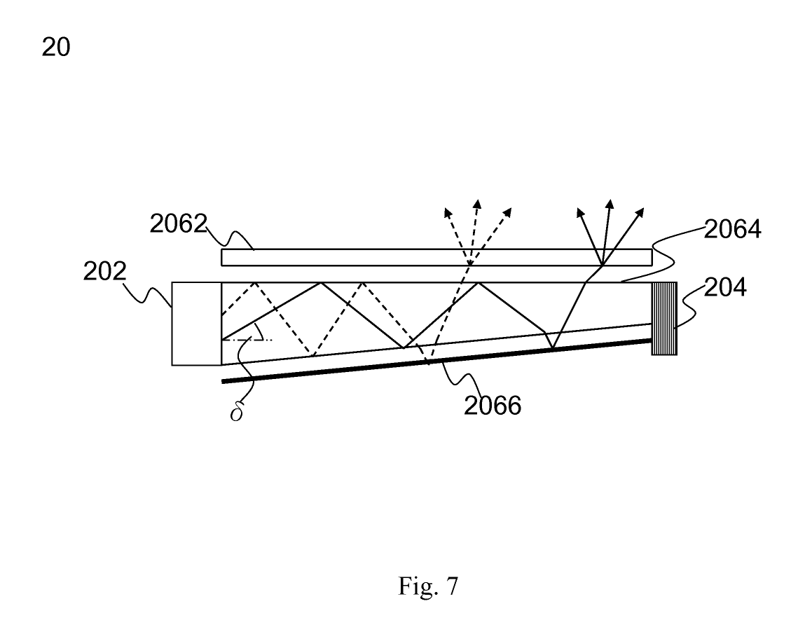

In order to have better understanding of the present invention, three cross-sections are used to illustrate the details. Please refer to FIG. 7. A cross-sectional view taken along line AA′ is illustrated. Light beams from the first light source array 202 have slight deviation angles δ from the horizontal direction. The light beams can emit out of the light guide 2064 to the diffusing sheet 2062. They can also be reflected by a top surface of the light guide 2064, emitted to the reflecting sheet 2066 and then reflected back to the light guide 2064. The light beams are then released to the diffusing sheet 2062. The solid line and dashed line in FIG. 7 show different light paths for light beams with different deviation angles δ. Hence, light beams can emit out at any point along line AA′ between the light source array 202 and the reflecting mirror 204. Backlighting function is thus accomplished. A wedge shape of the light guide 2064 can help light beams release.

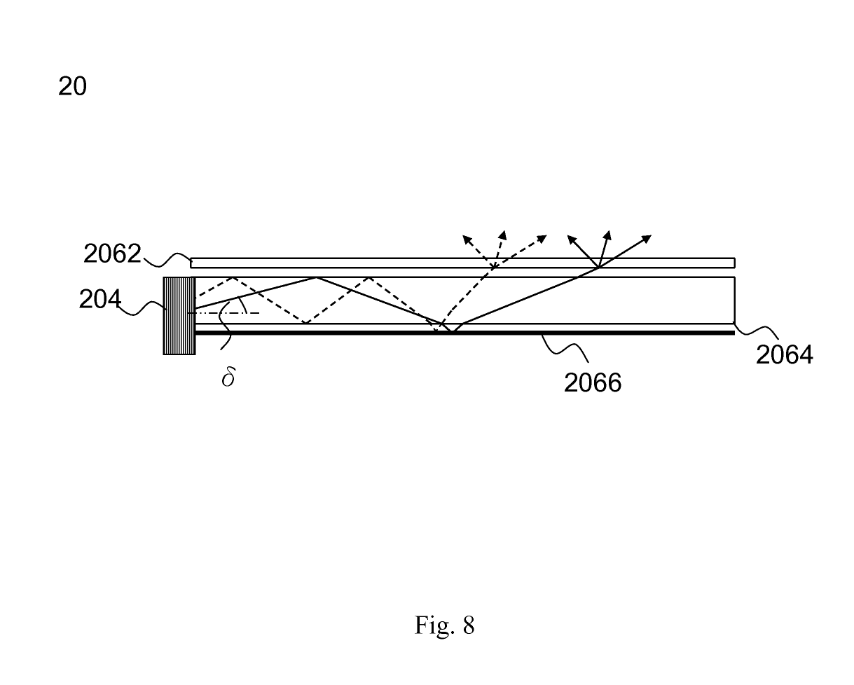

Please see FIG. 8. A cross-sectional view along line BB′ is illustrated. After being reflected by the reflecting mirror 204, light beams not going out of the light guide 2064 will propagate toward the direction in which they are reflected by the reflecting mirror 204. Of course, the light beams are still reflected between the top surface of the light guide 2064 and the reflecting sheet 2066 until emitting out of the light guide 2064. In other words, light beams can be released at any point along line BB′. The cross-section of the light guide 2064 taken along line BB′ has a rectangular shape and the reflecting sheet 2066 is horizontal.

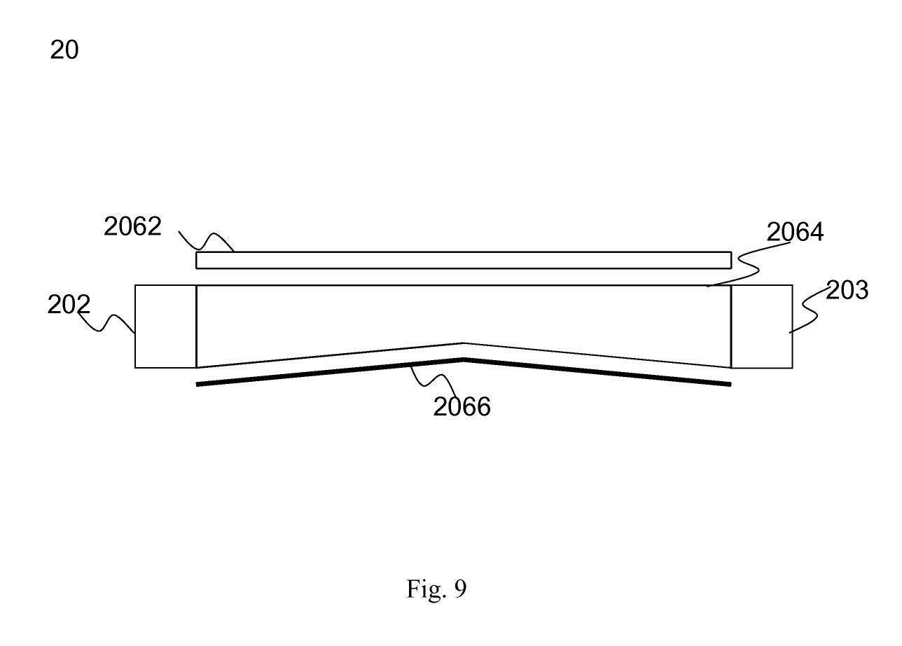

Last, FIG. 9 illustrates a cross-sectional view taken along line CC′. In order to have a good light extraction effect, design of the light guide 2064 has a largest thickness at the locations of the first light source array 202 and the second light source array 203. The thickness decreases towards the connecting line of the two reflecting mirrors 204 and 205.

Please notice that both of the reflecting mirrors 204 and 205 can reflect light beams across the rotation angles θ₁ and θ₂ and provide backlight across the area of the light guide 2064. In this embodiment, θ₁ equals to θ₂. According to FIG. 6, the reflected light beams of the reflecting mirrors 204 and 205 at rotation angles θ₁ and θ₂ are very close but with no overlapping.

### Second Embodiment

In the first embodiment, two light source arrays and two reflecting mirrors are used. The light source array and the reflecting mirror are assembled at adjacent corners of the light adjusting medium. However, if power of the light source array is enough, the present invention can be achieved by only using one light source array and one reflecting mirror. It is described in a second embodiment.

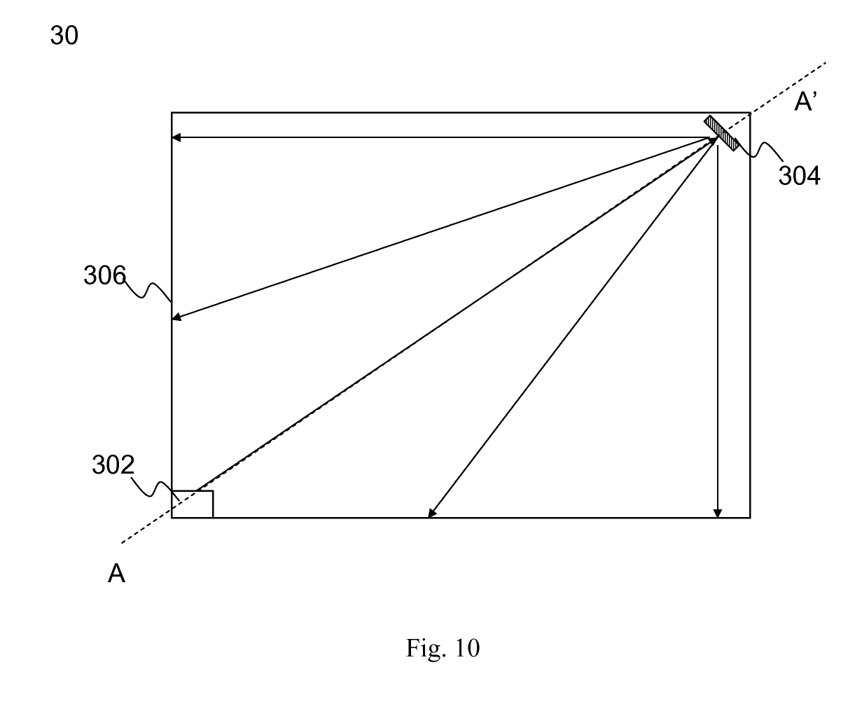

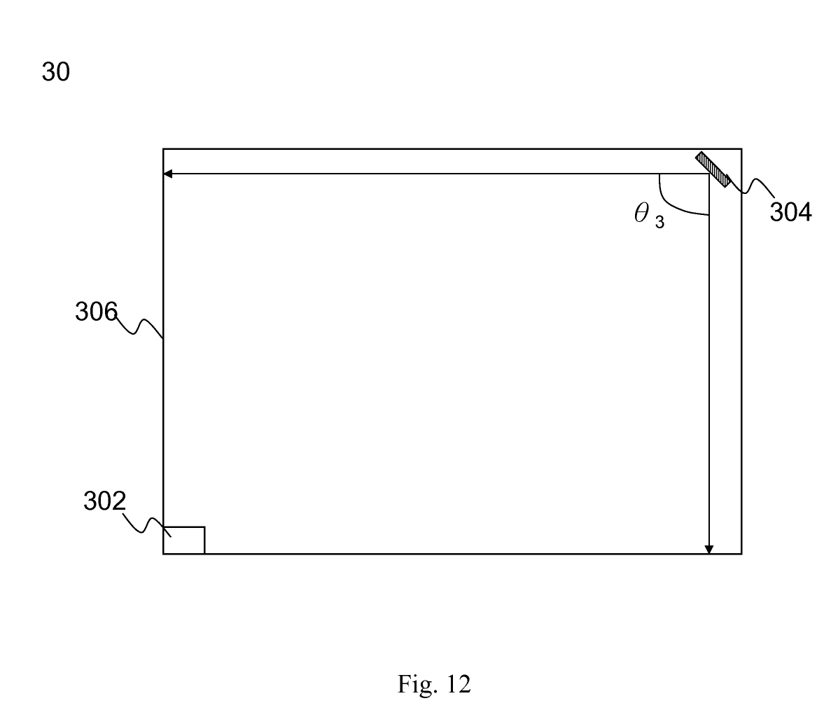

Please refer FIG. 10 and FIG. 12. An edge type backlighting module 30 has a light source array 302, a reflecting mirror 304 and a light adjusting medium 306. The light adjusting medium 306 has a light guide 3064, a reflecting sheet 3066, and a diffusing sheet 3062. Members having like functions are identified by like reference numerals and overlapping descriptions will be omitted.

The laser source used in this embodiment is different from that mentioned in the first embodiment. The light source array 302 generates light (laser) beams which are parallel to the surface of the light guide 3064. Therefore, when the light beams are reflected by the reflecting mirror 304, a deviation angle (not shown) must be formed for light emitting from the light guide 3064. A simple way to perform both horizontal and vertical rotation is by using a two-axle reflecting mirror. As mentioned in the first embodiment in which the reflecting mirror has a rotation axle perpendicular to the paperface of FIG. 5, one of the axles is perpendicular to the paperface of FIG. 10. The other axle is perpendicular to the one axle and falls on the paperface of FIG. 10. When the reflecting mirror 304 rotates around the one axle, light beams can be reflected with a deviation angle from the horizon direction to cause light beam reflection between a top surface of the light guide 3064 and the reflecting sheet 3066 until they emit out of the light guide 3064. Backlight is thus generated.

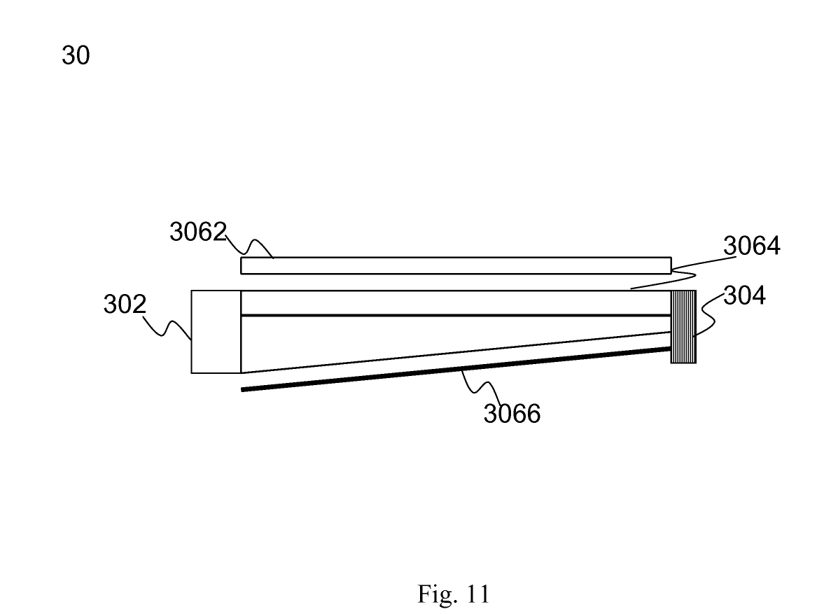

As shown in FIG. 11, the cross-section taken along line AA′ of the light guide 3064 is also a wedge. In this embodiment, all cross-sections are perpendicular to the paperface of FIG. 10 and passing through point A′ cut the light guide 3064 to form a wedge. The reason is to help light beams release from the light guide 3064 and generate backlight. FIG. 12 shows a rotation angle θ₃ which is 90° in this embodiment.

### Third Embodiment

The present invention can be implemented with one light source array and two reflecting mirrors.

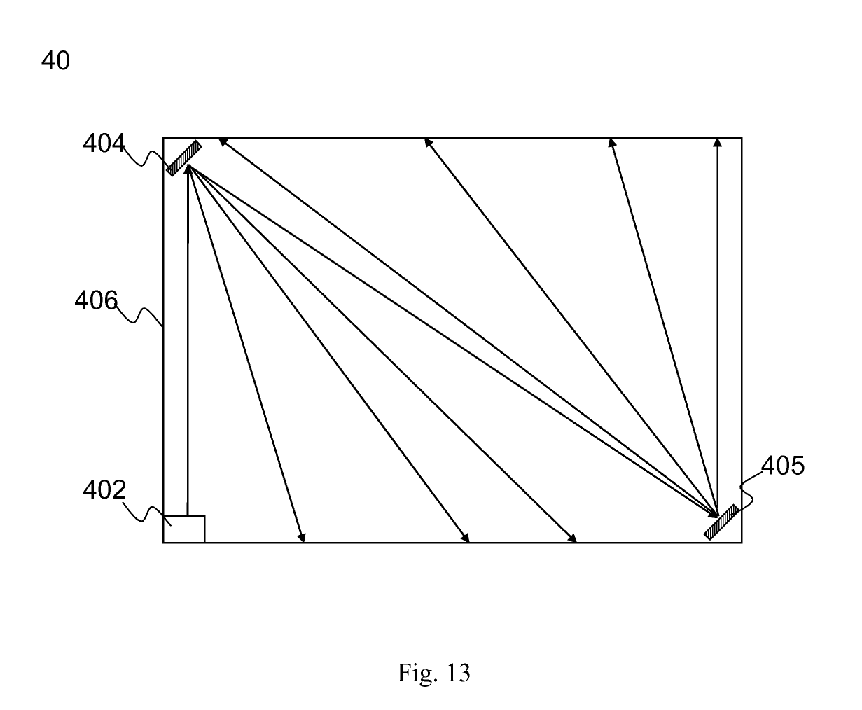

Please refer to FIG. 13. An edge type backlighting module 40 has a light source array 402, a first reflecting mirror 404, a second reflecting mirror 405 and a light adjusting medium 406. The first reflecting mirror 404 is used to reflect light beams to the bottom half of the light adjusting medium 406 and the second reflecting mirror 405. The second reflecting mirror 405 is used to reflect light beams from the first reflecting mirror 404 to the rest portion of the light adjusting medium 406. Therefore, backlighting is achieved.

### Fourth Embodiment

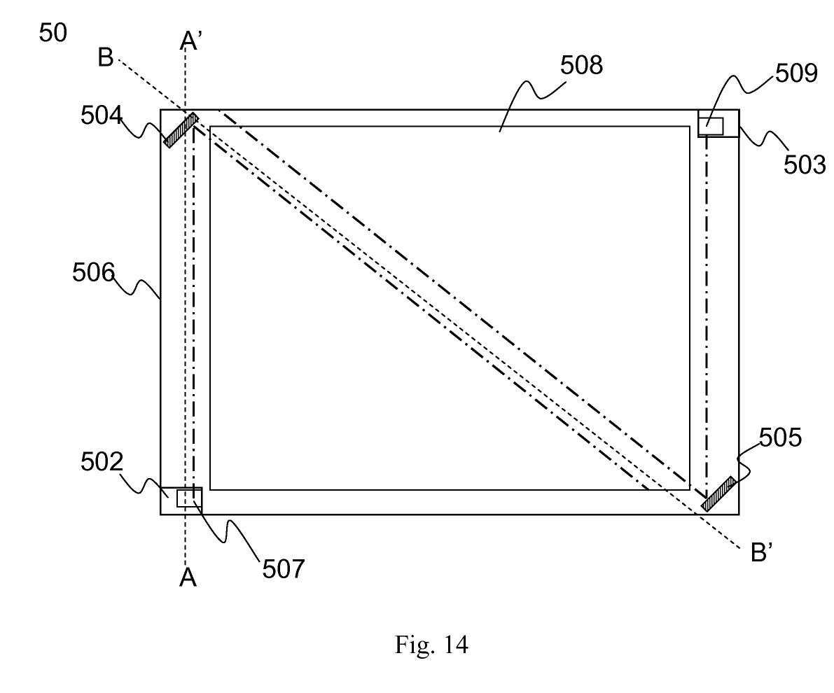

An infrared ray emitter and infrared sensor can be applied to the invention to provide touch functions. Please refer to FIG. 14 to FIG. 16. An edge type backlighting module 50 has a first light source array 502, a second light source array 503, a first reflecting mirror 504, a second reflecting mirror 505 and a light adjusting medium 506. The light adjusting medium 506 is composed of a light guide 5064, a reflecting sheet 5066 and a diffusing sheet 5062. Members having like functions are identified by like reference numerals and overlapping descriptions will be omitted.

Two infrared ray emitters 507 and 509 for emitting infrared rays are placed in the light adjusting medium 506 adjacent to the first light source array 502 and the second light source array 503, respectively, for emitting infrared rays having infrared paths parallel to the diffusing sheet 5062. In addition, the edge type backlighting module 50 has an infrared sensor 508 for detecting change of the infrared paths caused by depression of the light adjusting medium 506 generated by touch of a user on the edge type backlighting module 50, and generating a signal representing a touch location.

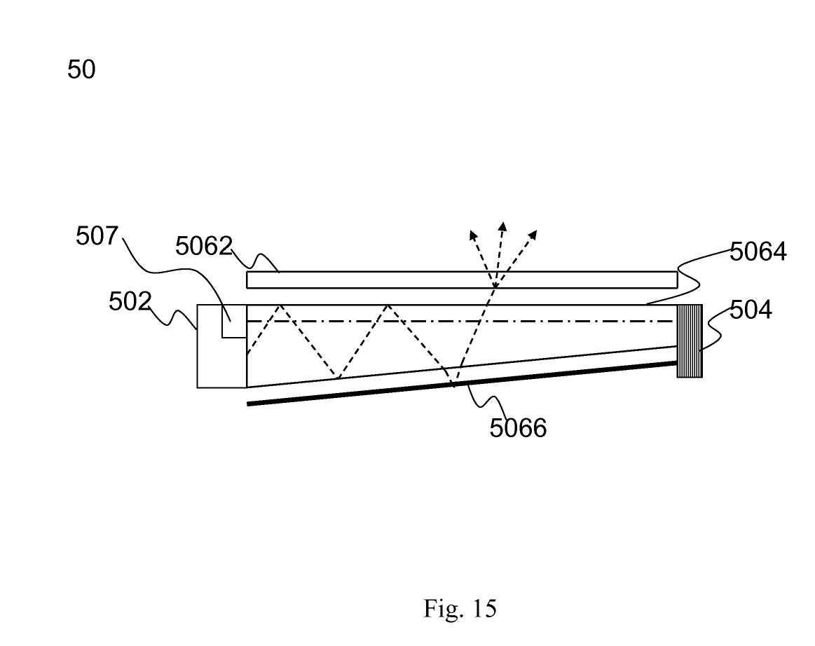

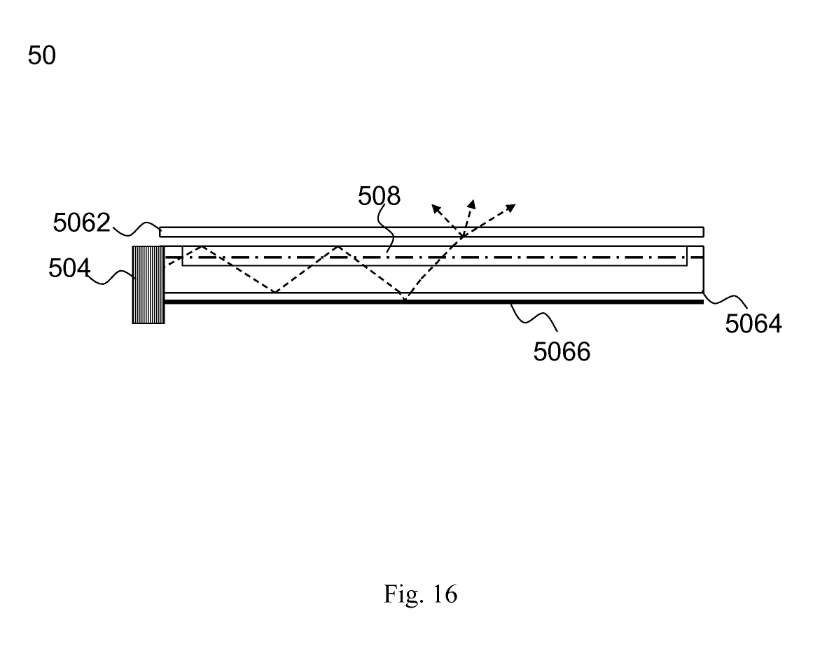

In order to make illustration clear, chain lines in FIG. 14 to FIG. 16 represent infrared rays. Light beams from laser diodes are not illustrated in FIG. 14 and are illustrated as dash lines in FIGS. 15 and 16 which are cross-sectional views taken along line AA′ and line BB′ in FIG. 14, respectively. The infrared rays are emitted parallel to the diffusing sheet 5062. FIG. 16 shows that the infrared sensor 508 can detects almost all infrared paths without blocking light beam reflection and emission. Number of the infrared sensor is not limited to one as long as change of the infrared paths can be detected. Once the edge type backlighting module 50 is touched, infrared paths are changed. Then, a touch function is triggered.

While the invention has been described in terms of what is presently considered to be the most practical and preferred embodiments, it is understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. An edge type backlighting module, comprising:
at least one light source array for providing light beams;
at least one reflecting mirror, rotating within a specified angle, for reflecting the light beams; and
a light adjusting medium for adjusting outgoing directions of the reflected light beams.

2. The backlighting module according to claim 1, wherein the light adjusting medium comprises:
a light guide for guiding the reflected light beams to uniformly illuminate from one end of the light guide to the other end thereof;
a reflecting sheet, attached below the light guide, for reflecting the reflected light beams back to the light guide; and
a diffusing sheet, provided on the light guide, for scattering the reflected light beams from the light guide.

3. The backlighting module according to claim 2, wherein the reflecting sheet is made of a metal.

4. The backlighting module according to claim 2, wherein the diffusing sheet is made of polyethylene terephthalate (PET) or polycarbonate (PC).

5. The backlighting module according to claim 2, wherein the diffusing sheet comprises a dispersing agent.

6. The backlighting module according to claim 5, wherein the dispersing agent is made of acrylic, silicon dioxide, aluminum oxide, calcium oxide, magnesium oxide, silicone gel, polyester resin or a mixture thereof.

7. The backlighting module according to claim 1, wherein the light source array and the reflecting mirror are assembled adjacent to each other.

8. The backlighting module according to claim 1, wherein the light source array and the reflecting mirror are assembled at adjacent corners of the light adjusting medium.

9. The backlighting module according to claim 1, wherein the reflecting mirrors are placed at diagonal corners of the light adjusting medium while the reflecting mirror has a number of two.

10. The backlighting module according to claim 1, wherein the light source array and the reflecting mirror have the same number.

11. The backlighting module according to claim 1, wherein the light source array comprises red, green and blue laser diodes (LD).

12. The backlighting module according to claim 2, further comprising at least one infrared ray emitter placed in the light adjusting medium adjacent to the light source array for emitting infrared rays having infrared paths parallel to the diffusing sheet.

13. The backlighting module according to claim 12, further comprising at least one infrared sensor for detecting change of the infrared paths caused by depression of the light adjusting medium generated by touch of a user on the edge type backlighting module, and generating a signal representing a touch location.

14. The backlighting module according to claim 1, wherein the reflecting mirror is a Micro Electro Mechanical Systems (MEMS) mirror.
